(19) United States
(12) Patent Application Publication
(10) Pub. No.: US 2014/0164474 A1
(43) Pub. Date: Jun. 12, 2014

(54) METHODS, SYSTEMS, AND PRODUCTS FOR PAIRING AGENTS AND SERVICE PROVIDERS

(71) Applicant: Qurio Holdings, Inc., Raleigh, NC (US)

(72) Inventors: Alfredo C. Issa, Apex, NC (US); Richard J. Walsh, Raleigh, NC (US); Gregory M. Evans, Raleigh, NC (US)

(73) Assignee: Qurio Holdings, Inc., Raleigh, NC (US)

(21) Appl. No.: 14/182,382

(22) Filed: Feb. 18, 2014

Related U.S. Application Data
(63) Continuation of application No. 11/479,518, filed on Jun. 30, 2006, now abandoned.

(51) Int. Cl. H04L 29/08

(52) U.S. Cl. CPC H04L 67/12
USPC 709/202

(57) ABSTRACT

Methods, systems, and products are disclosed for pairing agents and service providers. A registration request is received to pair an agent and a service provider. A directory service is queried that stores at least one of i) third party service providers and information describing each third party service provider's service and ii) agents and information associated with each agent. A response is sent that describes an available pairing between an agent and a service provider.

### PRIORITY CLAIM

The present application is a continuation of U.S. patent application Ser. No. 11/479,518, entitled METHODS, SYSTEMS, AND PRODUCTS FOR PAIRING AGENTS AND SERVICE PROVIDERS, which was filed on Jun. 30, 2006, which is incorporated by reference herein in its entirety for all purposes.

### BACKGROUND

This application particularly relates to pairing agents with service providers to dynamically bind communications devices to remote services.

Service providers and their customers could benefit from dynamic configuration settings. When a user operates their communications device, its switches, buttons, display, and other hardware and software parameters are defined by configuration settings. These configuration settings, however, are usually hard coded and not modifiable. The service provider must provide their service (e.g., messaging service, data service, or video service) using the device's hard-coded configuration settings. If, however, the service provider could alter those configuration settings, the service provider could tailor their customers' communications devices to optimally provide a service. What is needed, then, are methods, systems, and products that pair a service provider with a user's communications device, such that the user's communications device agrees to accept configurations and services suggested by the service provider.

### SUMMARY

The problems noted above, along with other problems, may be reduced or eliminated by embodiments of the present invention using methods, systems, and products that pair service providers with user agents. Each user's communications device stores and executes a user agent. The user agent is a software application that negotiates on behalf of the user when pairing with a service provider. If the negotiation is successful, the user's agent allows the service provider to dynamically alter configuration settings. When the user's agent and the service provider pair, the user's agent agrees to accept configurations and services suggested by the service provider. That is, when pairing occurs, the user's agent agrees to accept third party control of the user's communications device. The user's agent and the service provider negotiate to dynamically configure the user's communications device according to the service provided by the service provider. The present invention, then, allows a service provider to dynamically configure switches, buttons, software/hardware controls, and/or displays to best suit the service.

According to aspects of the present invention, a method is disclosed for pairing agents and service providers. A registration request is received to pair a user's agent and a service provider. When the user's agent and the service provider pair, the user's agent agrees to accept configurations and services suggested by the service provider. The service provider may be any real or corporate person that provides third party services, such as, but not limited to, mapping or location-based services, e-commerce services, messaging services, food services, and transportation services. A directory service is queried that stores at least one of i) third party service providers and information describing each third party service provider's service and ii) agents and information associated with each agent. The term “third party” means a service provider other than a communications network provider. A response is sent that describes an available pairing between an agent and a service provider.

According to another aspect of the present invention, another method is disclosed that pairs agents and service providers. A service provider registers with a directory service that pairs the agents and the service providers. An available pairing is received from the directory service, and an invitation is sent to an agent to pair with the service provider.

Still other aspects of the present invention describe a system that pairs agents and service providers. A pairing application is stored in memory, and a processor communicates with the memory and with the pairing application. The system registers with a directory service that pairs agents and service providers. The system receives an available pairing from the directory service, and the system sends an invitation to an agent to pair with a service provider.

In yet another aspect, a computer program product pairs agents and service providers. The computer program product comprises a computer-readable medium storing computer-readable instructions. These instructions cause registration with a directory service that pairs the agents and the service providers. An available pairing is received from the directory service, and an invitation is sent to an agent to pair with the service provider.

In another aspect of the present invention, another computer program product pairs agents and service providers. A registration request is received to pair an agent and a service provider. A directory service is queried that stores agents and service providers. The directory service stores searchable metadata and other information describing each agent, each service provider, and each service provider's service. A query response is received that describes an available pairing. A registration response is sent that describes the available pairing.

Other aspects, including systems, methods, and/or computer program products according to the present invention will be or become apparent to one with ordinary skill in the art upon review of the following drawings and detailed description. Such additional aspects, including systems, methods, and/or computer program products, are included within the scope of the present invention.

### BRIEF DESCRIPTION OF THE SEVERAL VIEWS OF THE DRAWINGS

The accompanying drawing figures incorporated in and forming a part of this specification illustrate several aspects, features, principles and advantages of the present invention, and together with the Detailed Description serve to better explain the aspects, features, principles, and advantages of the invention.

FIG. 1 is a schematic illustrating a network environment in which exemplary embodiments of the present invention may be implemented.

FIG. 2 is a schematic illustrating a directory service, according to more exemplary embodiments of the present invention.

FIG. 3 is a schematic illustrating a layered architecture for a user's communications device, according to yet more exemplary embodiments of the present invention.

FIG. 4 is a schematic illustrating an example of a switchable, controllable, or configurable devices or components, according to exemplary embodiments of the present invention.

FIGS. 5 and 6 are schematics illustrating a process for pairing agents and service providers, according to even more exemplary embodiments of the present invention.

FIG. 7 is a flowchart illustrating a method for pairing agents and service providers, according to still more exemplary embodiments of the present invention.

FIG. 8 depicts other possible operating environments for additional aspects of the present invention.

### DETAILED DESCRIPTION

The present invention now will be described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure will convey the invention to those skilled in the art.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

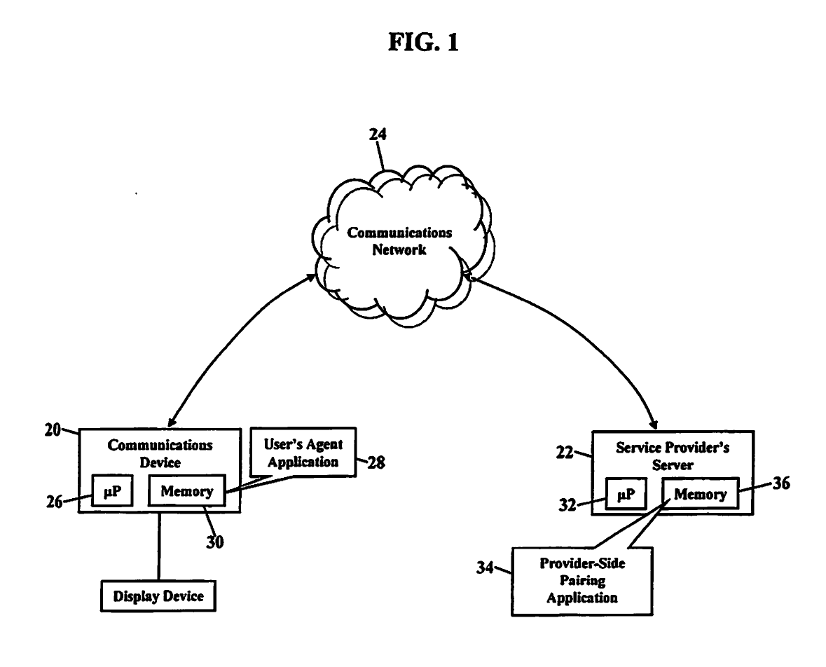

FIG. 1 is a schematic illustrating a network environment in which exemplary embodiments of the present invention may be implemented. A user's communications device 20 communicates with at least one service provider's server 22 via a communications network 24. The user's communications device 20 has a processor 26 (e.g., “μP”), application specific integrated circuit (ASIC), or other similar device that executes an agent application 28 stored in memory 30. The service provider's server 22 likewise has a processor (“P”) 32 (or ASIC or other similar device) executing a provider-side pairing application 34 stored in memory 36. The user's agent application 28 and the provider-side pairing application 34 cooperate to “pair” the user's communications device 20 with the service provider's server 22. That is, the agent application 28 acts as the user's software agent and negotiates with the server 22 for third party control of the user's communications device 20. The provider-side pairing application 34 similarly acts as the service provider's agent during those negotiations. The user's agent application 28 and the provider-side pairing application 34 negotiate to dynamically configure the user's communications device 20 according to the service provided by the service provider's server 22. Because the user's communications device 20 may comprise one or more configurable switches, buttons, software/hardware controls, and/or displays, the service provider may desire to configure the user's communications device 20 to best suit the service. Once that service is provided, or perhaps when the user's communications device 20 moves beyond a service area, the user's agent application 28 may negotiate with a new service provider or may return to a default configuration. Whereas hardware and software configuration is usually hard coded, the present invention permits service providers to configure the user's communications device 20 when providing a service.

The user's communications device 20 and the service provider's server 22 pair together and negotiate configuration settings. The terms “pair,” “pairs,” “pairing,” and similar terms describe a process by which the user's agent application 28 agrees to accept configurations and services suggested by the remote service provider (e.g., the service provider's server 22). The user's communications device 20 and the service provider's server 22 pair together to configure the user's communications device 20 for the service. The service provider may wish to bind keys, configure a switch, and/or configure a display device. Suppose, for example, that the service provider is “Vinnie's Pizza.” If the user wishes to order a pizza from Vinnie's, the user may agree to accept settings, controls, web links, and other configurations specified by, and/or obtained from, Vinnie's Pizza. These configurations alter switches, buttons, and/or controls to optimally present content specified by Vinnie's Pizza.

Some aspects of software agents are known, so this disclosure will not greatly explain the known details. If, however, the reader desires more details, the reader is invited to consult the following sources, all incorporated herein by reference in their entirety: U.S. Pat. No. 6,915,129 to Kovacs (Jul. 5, 2005); U.S. Pat. No. 5,867,729 to Swonk (Feb. 2, 1999); U.S. Pat. No. 6,741,853 to Jiang et al. (May 25, 2004); U.S. Pat. No. 6,941,148 to Hansmann et al. (Sep. 6, 2005); Published U.S. Patent Application 2004/0110497 to Little (Jun. 10, 2004); Published U.S. Patent Application 2004/0203685 to Woodward et al. (Oct. 14, 2004); Published U.S. Patent Application 2004/0214560 to Date et al. (Oct. 28, 2004); Published U.S. Patent Application 2005/0048961 to Ribaudo et al. (Mar. 3, 2005); Published U.S. Patent Application 2005/0128995 to Ott (Jun. 16, 2005); Published U.S. Patent Application 2005/0256876 to Eidson (Nov. 17, 2005); Published U.S. Patent Application 2006/0009204 to Ophir (Jan. 12, 2006); and Published U.S. Patent Application 2006/0084477 to Wardimon et al. (Apr. 20, 2006).

The user's communications device 20 and the service provider's server 22 are only simply illustrated. Moreover, the service provider need not utilize a computer server, but, instead, may likewise utilize any communications device. Because the architecture and operating principles of computers and other communications are well known, the detailed hardware and software components are not further shown and described. If the reader desires more details, the reader is invited to consult the following sources, all incorporated herein by reference in their entirety: ANDREW TANENBAUM, COMPUTER NETWORKS (4^{th} edition 2003); WILLIAM STALLINGS, COMPUTER ORGANIZATION AND ARCHITECTURE: DESIGNING FOR PERFORMANCE (7^{th} Ed., 2005); and DAVID A. PATTERSON & JOHN L. HENNESSY, COMPUTER ORGANIZATION AND DESIGN: THE HARDWARE/SOFTWARE INTERFACE (3^{rd}. Edition 2004).

The exemplary embodiments may be applied regardless of networking environment. The user's communications device 20 and the service provider's server 22 may operate using wired or wireless principles. The communications network 24 may be a cable network operating in the radio-frequency domain and/or the Internet Protocol (IP) domain. The communications network 24 may have Plain Old Telephone Service (POTS) components and/or features. The communications network 24, however, may also include a distributed computing network, such as the Internet (sometimes alternatively known as the “World Wide Web”), an intranet, a local-area network (LAN), and/or a wide-area network (WAN). The communications network 24 may include coaxial cables, copper wires, fiber optic lines, and/or hybrid-coaxial lines. The communications network 24 may include wireless portions utilizing any portion of the electromagnetic spectrum and any signaling standard (such as the I.E.E.E. 802 family of standards, GSM/CDMA/TDMA or any cellular standard, and/or the ISM band). The communications network 24 may even include free-space optics and/or ultrasound communication components and/or features. The concepts described herein may be applied to any wireless/wireline communications network or communications device, regardless of physical componentry, physical configuration, or communications standard(s).

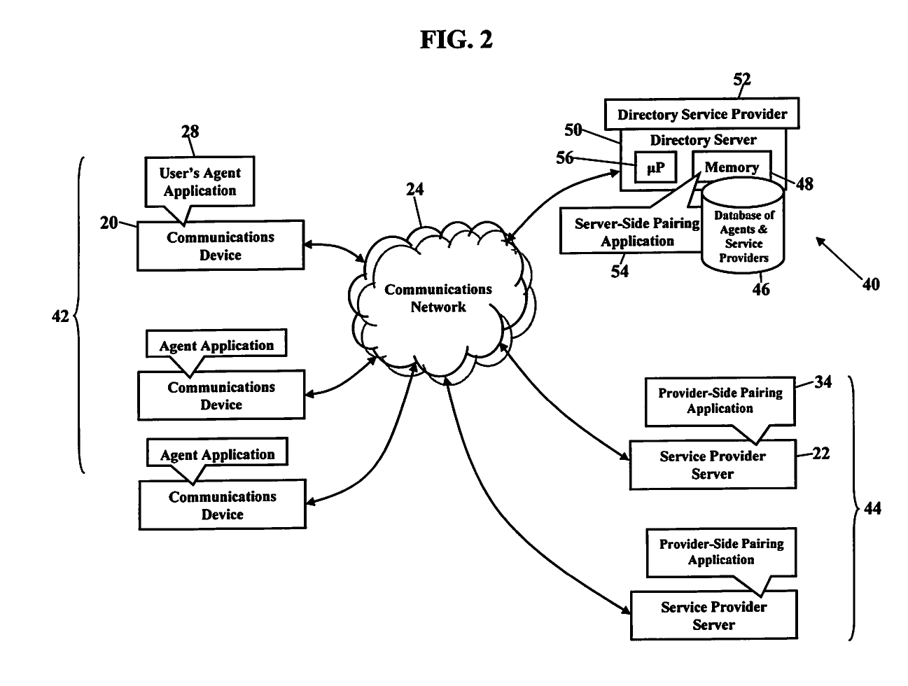

FIG. 2 is a schematic illustrating a directory service 40, according to more exemplary embodiments of the present invention. The directory service 40 communicates with one or more agent applications 42 and one or more service provider servers 44. The directory service 40 includes a database 46 that is stored in the memory 48 of a directory server 50. Although not shown, the directory service 40 may additionally or alternatively be distributed across the communications network 24, such as in a peer-to-peer environment. The directory server 50 is operated by, or on behalf of, a directory service provider 52. The directory service 40 maintains a dynamic listing of user agents and service providers. Each agent application 42, for example, may register with the directory service 40. Each service provider may also register with the directory service 40. The directory service 40 may additionally or alternatively discover agents and service providers without requiring registration. The directory service 40 thus maintains the database 46 of agents and service providers that are available for pairings. When an agent application 42, for example, wishes to obtain third party services, the agent application 42 queries a server-side pairing application 54 stored in the memory 48 of the directory server 50. The server-side pairing application 54 is a software application or engine that pairs mobile agents and service providers. The server-side pairing application 54 instructs a processor (“μP”) 56 (or ASIC or other similar device) to access the database 46 and obtain a service provider matching the search query. Service providers, similarly, may query the directory service 40 for users matching the service provider's search query. The database 46 thus identifies agents that are available to pair with a remote service. The database 46 also identifies third party service providers that are available to pair with agents.

The directory service 40 may also include information describing each user's agent. When each user's agent application 42 registers with the directory service 40, the user may reveal as much, or as little, information as desired. The user's agent application 42, for example, may be configured to communicate searchable information and/or metadata describing the communications device's historical or current location. If the user's agent application 42 divulges a current location (such as GPS coordinates), then the directory service 40 could query for a service provider serving that current location. If the user wishes to reveal personal information, the user's agent application 42 may communicate the user's name, address, family members, family relationships, interests, and preferences. If, for example, the user reveals a family member's birthday or other occasion, the directory service 40 could pair a service provider to obtain a birthday gift. The user may also wish to reveal music, movies, pictures, and other content stored in the memory 30 of the communications device 20. If this content is published to the directory service 40, either the directory service 40 or a service provider could profile the user. The user may also wish to reveal content metadata, such as categories, genres, or titles of music and movies stored in the memory 30 of the communications device 20. Each user's agent application 42 may also communicate information describing the user and/or each user's respective communications device. Each user's agent application 42 may reveal a manufacturer or model number, an operating system, or hardware and software components. Each user's agent application 42 may also communicate Composite Capability/Preference Profile (CC/PP) information. As those of ordinary skill in the art understand, CC/PP information provides a structure and a vocabulary for describing a communications device's hardware capabilities, software capabilities, and user preferences. Because Composite Capability/Preference Profile information is already known, this specification will not provide a detailed explanation of such information. If, however, the reader desires a detailed explanation, the reader is invited to consult W3C, Composite Capability/Preference Profiles (CC/PP): Structure and Vocabularies, available from the World Wide Web Consortium (W3C), 32 Vassar Street, Room 32-G515, Cambridge, Mass. 02139 USA and from the European Office of the World Wide Web Consortium (W3C), 2004, route des Lucioles, BP 93, 06902 Sophia-Antipolis Cedex France, and incorporated herein by reference in its entirety.

The directory service 40 may also include information or metadata describing service providers. When a service provider 44 registers with the directory service 40, the service provider may also communicate searchable information and/or metadata that helps obtain pairings. Service providers, for example, may communicate information that describes their hours, their services, their qualifications, their products, and their geographic service locations. Service providers may also communicate desires and preferences for pairings. Some service providers, for example, may only wish to be paired with communications devices having a certain performance capability (e.g., processor, memory, or display device) or user/content profile. Some service providers may only wish to be paired with communications devices having subscription or membership qualities that indicate pre-existing relationships. A third-party museum, for example, may query for agents that indicate donor or patronage memberships with the museum. Each service provider, then, may generally or specifically describe their desired pairings.

The agent applications 42 and the service providers 44 may update the directory service 40. If the directory service 40 stores stale information, then the server-side pairing application 54 may imperfectly pair a mobile agent with a service provider. Suppose, for example, that a user wishes to obtain pizza delivery, but the user's location information is not current. The directory service 40 may then erroneously or imperfectly pair that agent with a pizzeria that is unable to deliver to the user's current location. The directory service 40, then, may randomly or periodically receive registration updates from the agent applications 42 and from the service providers 44. Current registration information may also be communicated on an event basis, such that the occurrence of the event triggers an update.

User agents may automatically query the directory service 40. The user's agent application 28 may search the directory service 40 for a third party service provider. When the user's agent application 28 desires a pairing, the user's communications device 20 may automatically send a search query for selecting a third party service provider. In this automatic scenario, the user's agent application 28 may poll the directory service 40 for remote service providers. The user's agent application 28, for example, may query the directory service 40 for a remote service provider based on historical pairings within a geographic location. The user's agent application 28, or the directory service 40, may store a log of historical pairings with service providers (or types of service providers). This log may describe pairings within a geographic boundary, so that the user's agent application 28 may query for that same or similar service provider whenever in the vicinity of the same geographic location. The log of historical pairings may also be based on time, such that each log entry describes the date and/or time of each historical pairing and the service provider (or type of service provider). The user's agent application 28 may thus query to automatically pair with the same or similar service provider at a particular date or time. The user's agent application 28 may also automatically send queries based on a negotiated quality of service. The user, for example, may configure the user's agent application 28 to automatically pair with the cheapest messaging/data service, with the fastest available service provider, with the most secure service provider, with the service provider having the highest quality video transfer capability, or with any other service provider able to provide a desired quality of service.

User agents may also search for service providers. The user's agent application 28 may send one or more queries for a particular service provider, for a particular category of service provider, and/or for a particular type of service provider. The user's agent application 28 may even query for semantic terms and/or for desired content or service offerings. The user may instruct the agent application 28 to find all fast food service providers that will deliver within the vicinity of the user's current location. The agent application 28 queries the directory service 40, including a current location. The directory service 40 sends a query result describing fast food service providers associated with the user's current location. The user may then select a desired service provider and request a pairing.

Service providers may also query the directory service 40. The service providers 44 may query the directory service 40 for user agent applications. When a service provider desires a pairing, the service provider's server 44 (e.g., the provider-side pairing application 34) sends a search query to the directory service 40 for selecting one or more agent applications. When the directory service 40 returns the query results, the service provider's server 44 may then invite a particular agent to pair. The invited user may review the invitation and may accept or decline the suggested pairing. Because the directory service 40 may store searchable information/metadata that describes users, user agents, content, or devices, a service provider 44 may query for search results that match detailed or specific search criteria. A service provider 44, for example, may search for all communications devices associated with male owners over 40 and storing classic rock music files. The directory service 40 may be queried for all communications devices currently associated with ZIP code 07082 and which are not already paired. Service providers may also query for communications devices having a certain configuration, profile, or hardware/software specification.

Agents and service providers may query based on history. Either an agent or a service provider may query for historical pairings or interactions. The user's agent application 28, the server-side pairing application 54, and/or the directory service 40 may store or maintain a log of historical pairings. The log of historical pairings may describe each pairing. Frequent or recurring pairings, then, may indicate a “favorite” agent/provider relationship that can be exploited for quick query responses. A historical pairing with a restaurant, for example, may be used to automatically request a favorite dish or order. When the user accepts a pairing with a restaurant, the user's agent application 28 may retrieve and suggest metadata that describes a previous order from that same restaurant. The user may quickly accept this order suggestion, thus relying on the log of historical pairings for a satisfying meal from a known service provider. Historical pairings, then, may be used to suggest not only preferred service providers, but also services from preferred providers.

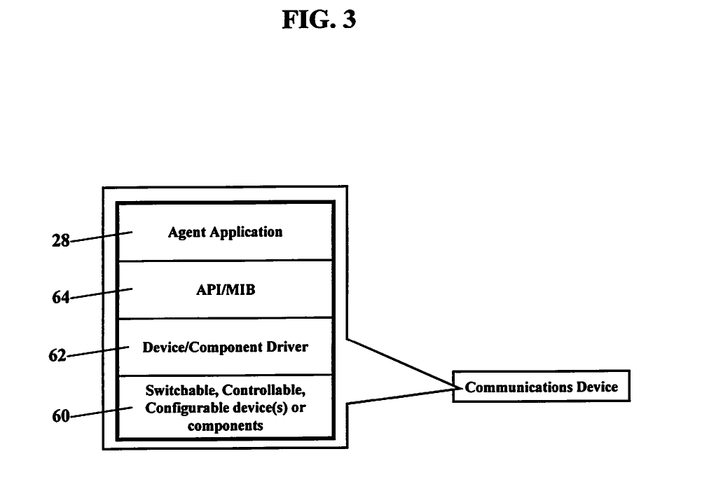

FIG. 3 is a schematic illustrating a layered architecture for the user's communications device 20, according to yet more exemplary embodiments of the present invention. Here the user's communications device 20 includes one or more switchable, controllable, or configurable devices or components 60. The user's communications device 20, for example, may comprise a configurable switch or button, configurable software or hardware controls, and/or a configurable display device. A device or component driver 62 exposes software controls for the switchable, controllable, or configurable devices. An API/MIB layer 64 exposes one or more sets of functionality that are available to the agent application 28. As those of ordinary skill in the art understand, an application programming interface (API) defines a common or standard software function, command, or request. The API/MIB layer 64 permits any service provider's pairing application 34 to make requests or to exchange data with the agent application 28. The agent application 28 is thus one part or member of an ecosystem of multiple, transient agents and remote “third party” services that are negotiating for control of the switchable, controllable, or configurable devices or components 60.

Each service provider makes their service(s) available to the agent applications 42. The service provider's server 22 exposes their service to the user's agent application 28 and/or the directory service 40. (The service provider's server 22 may also expose their service to the other service providers 44 shown in FIG. 2.) The third party service provider makes their functionality available to the user's agent application 28 via the one or more switchable, controllable, or configurable devices or components 60. The service provider's server 22 may support any API/MIB. The service provider's server 22, however, preferably supports a common and/or well-understood remote API that is exposed via web services. This common API helps reduce compatibility problems between dysfunctional hardware and/or software.

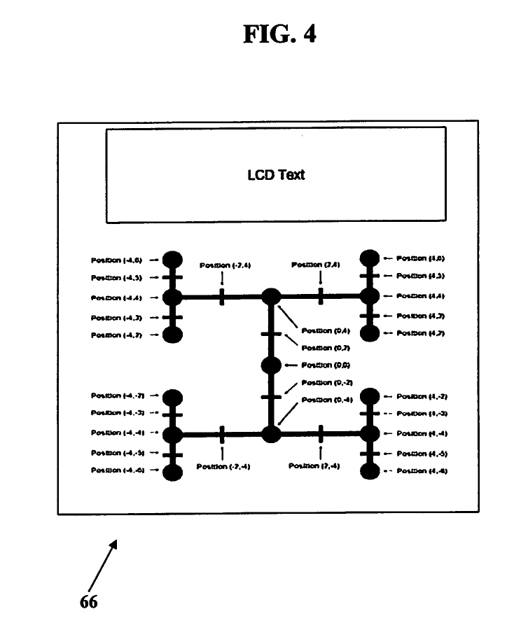

FIG. 4 is a schematic illustrating an example of the switchable, controllable, or configurable devices or components 60, according to exemplary embodiments of the present invention. When the user agrees to pair with a remote service provider, the user's agent application 28 accepts configurations and services suggested from the service provider's server 22. The service provider may wish to configure the switchable, controllable, or configurable devices or components 60 and perhaps display text that represents the service. FIG. 4, then, illustrates an exemplary embodiment of a configurable switch 66 having the following paired functionality, as described in pseudo-code:
if the switch is in position (0,0), display “Welcome to Vinnie's Pizza”;
if the switch is in position (4,−6), display help contents;
if the switch is in position (4,6) invoke: http://vinnies.com/pizza?id=23433 and display “Ordering large deluxe pizza and sending you your home address”;
if the switch is in position (−4,6) invoke: http://vinnies.com/cancel?id=23433 and display “Canceling last order”; and
if the switch is in position (−4,−6) invoke: http://vinnies.com/pizza?id=23433 and display “Ordering large deluxe pizza and sending you your home address.”
   Here, then, the service provider dynamically binds buttons or keys on the user's communications device 20 to a service across the Internet. The service provider dynamically binds those buttons/keys based on the agent application 28 exposing configuration information. The user's agent application 28 exposes configuration information about the user, the user's preferences, and/or the communications device 20. When the third party service provider receives this configuration information, the service provider dynamically determines what services to bind and in what order. The configuration information may include the number of positions available on the configurable switch 66, a switch map, a type and/or a size of an available display device, and/or which of the user's button preferences (e.g., up/right) is most comfortable or preferable.

Multiple services providers may control the user's communications device 20. The user's agent application 28 exposes configuration information, that configuration information may be shared by multiple service providers. That is, exemplary embodiments permit multiple service providers to share or to divide control of the user's communications device 20. One service provider, for example, may control a touch screen, while another service provider is given control of a keypad. The user's agent application 28 could split a display screen, thus giving a service provider control over one-half of the display, while another service provider simultaneously controls the other half of the display. Another example could give control of the display to one service provider, while another service provider controls an audio system. Multiple service providers, then, may co-habitate or cooperatively control the user's communications device 20.

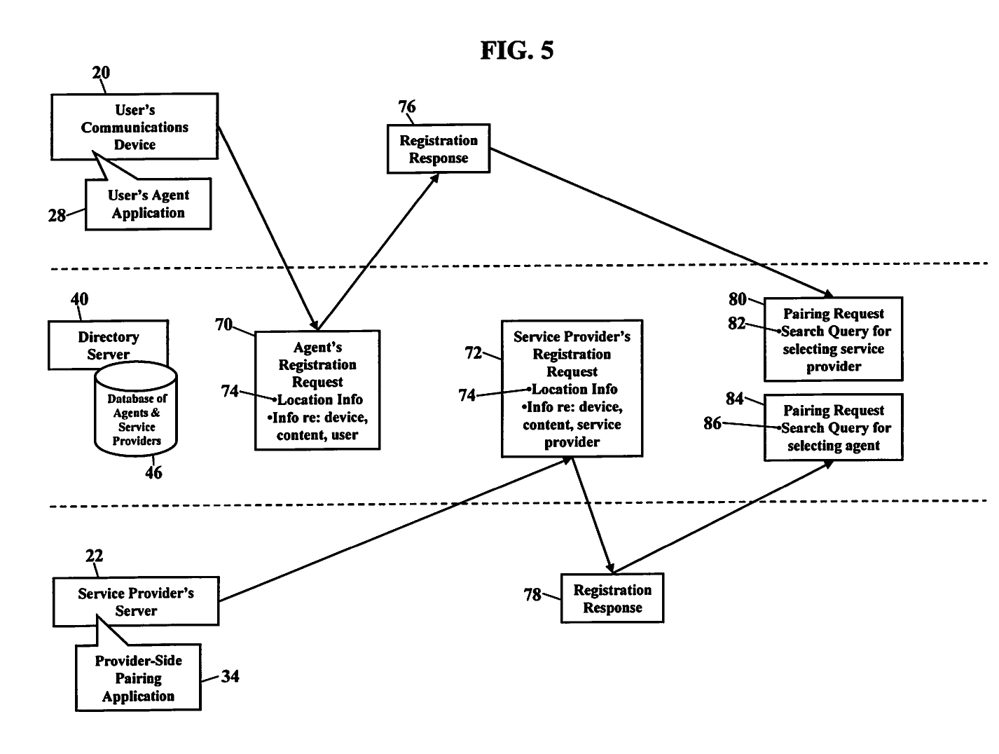

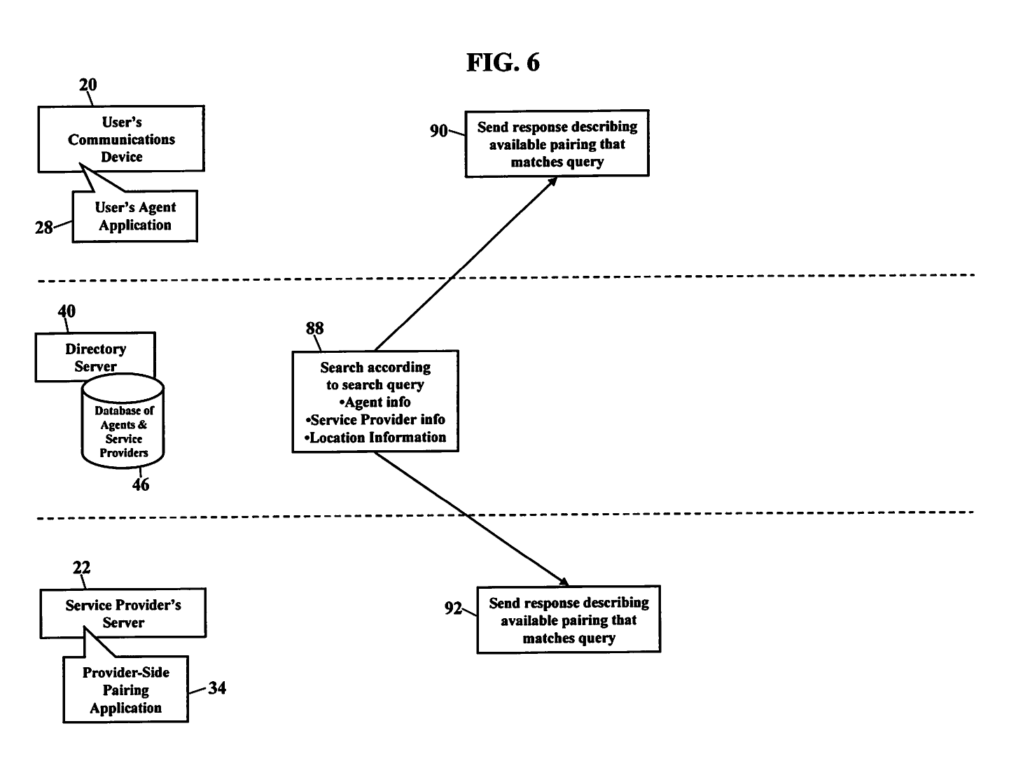

FIGS. 5 and 6 are schematics illustrating a process for pairing agents and service providers, according to even more exemplary embodiments of the present invention. The user's communications device 20 sends a registration request to the directory service 40 (Step 70). The service provider's server 22 may also send a registration request to the directory service 40 (Step 72). Either registration request may include location information 74 describing a location of the requesting device (e.g., the user's communications device 20 or the service provider's server 22). Either registration request may also include i) information describing the requesting device, ii) information describing content stored on the requesting device, and/or iii) information describing a user or entity associated with the requesting device. When the directory service 40 receives either registration request, the directory service 40 may return a registration response that confirms either registration (Steps 76 and 78). When the user desires a pairing, the user's communications device 20 sends a pairing request to the directory service 40 (Step 80). The pairing request may include a search query 82 for selecting a third party service provider. The pairing request, for example, may include service provider information that describes a desired third party service provider. When the third party service provider desires a pairing, the provider-side pairing application 34 also sends a pairing request to the directory service 40 (Step 84), and the pairing request may include a search query 86 for selecting an agent.

The process continues with FIG. 6. The directory service 40 performs a search according to the respective search query (Step 88). The directory service 40, for example, may search the database 46 that stores third party service providers and information describing each third party service provider's service. The database 46 may additionally or alternatively store and search agents and information associated with each agent. If either search query includes the location information 74, the directory service 40 may query for a third party service provider or mobile agent associated with the location information or offering a service within a vicinity of the location information 74. The directory service 40 may then send responses describing an available pairing between an agent and a third party service provider (Steps 90 and 92).

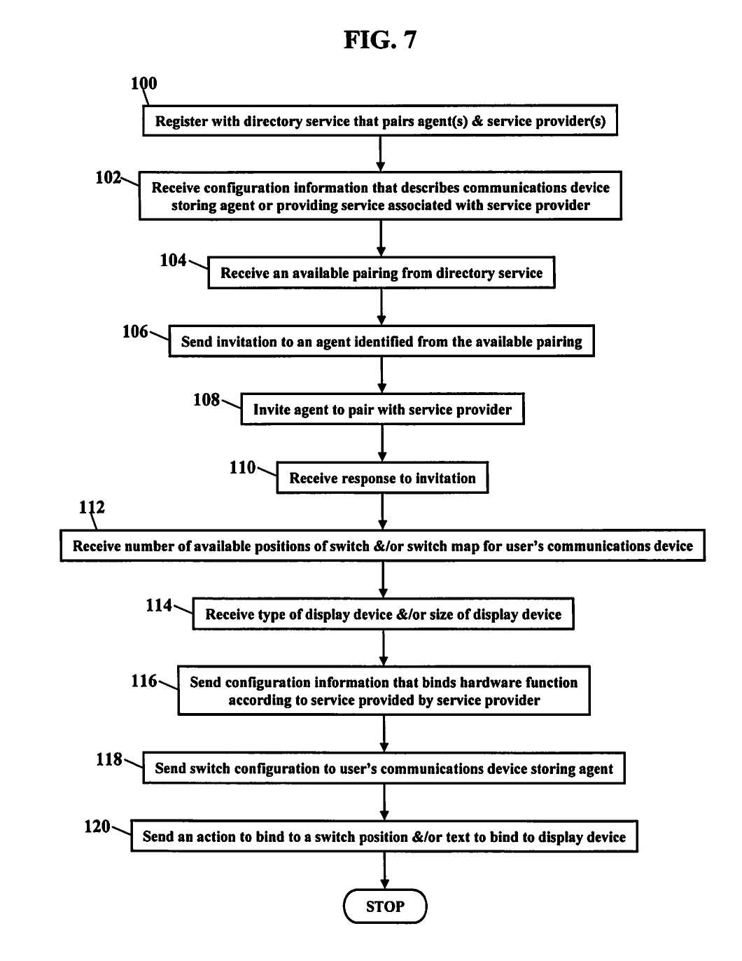

FIG. 7 is a flowchart illustrating a method for pairing agents and service providers, according to still more exemplary embodiments of the present invention. A remote third party service provider or agent registers with a directory service that pairs agents and service providers (Block 100). Configuration information may be received that describes a communications device storing the agent or providing a service associated with the service provider (Block 102). An available pairing is received from the directory service (Block 104). The service provider then sends an invitation to an agent identified from the available pairing (Block 106). The invitation invites the agent to pair with the service provider (Block 108). A response to the invitation is received (Block 110). The service provider may receive the number of available positions of a switch and/or a switch map for the user's communications device (Block 112). The service provider may receive a type of a display device and/or a size of the display device (Block 114). The service provider may send configuration information that binds a hardware function according to a service provided by the service provider (Block 116). The service provider may send a switch configuration to the user's communications device storing the agent (Block 118). The service provider may send an action to bind to a switch position and/or text to bind to the display device (Block 120).

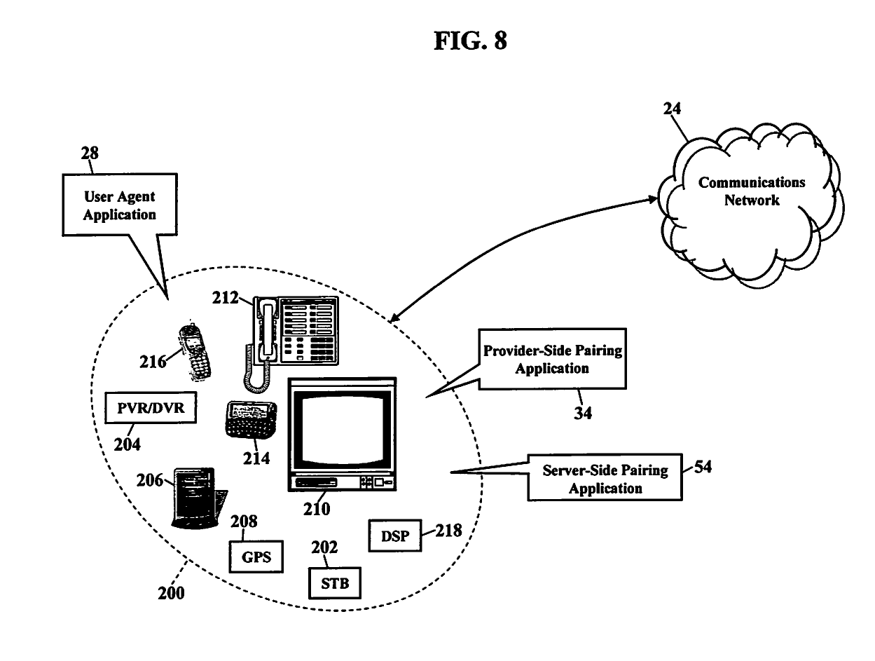

FIG. 8 depicts other possible operating environments for additional aspects of the present invention. FIG. 8 illustrates that the user agent application 28, the provider-side pairing application 34, and/or the server-side pairing application 54 may alternatively or additionally operate within various other communications devices 200. FIG. 8, for example, illustrates that the user agent application 28, the provider-side pairing application 34, and/or the server-side pairing application 54 may entirely or partially operate within a set-top box (202), a personal/digital video recorder (PVR/DVR) 204, personal digital assistant (PDA) 206, a Global Positioning System (GPS) device 208, an interactive television 210, an Internet Protocol (IP) phone 212, a pager 214, a cellular/satellite phone 216, or any computer system and/or communications device utilizing a digital signal processor (DSP) 218. The communications device 200 may also include watches, radios, vehicle electronics, clocks, printers, gateways, and other apparatuses and systems. Because the architecture and operating principles of the various communications devices 200 are well known, the hardware and software componentry of the various communications devices 200 are not further shown and described. If, however, the reader desires more details, the reader is invited to consult the following sources, all incorporated herein by reference in their entirety: LAWRENCE HARTE et al., GSM SUPERPHONES (1999); SIEGMUND REDL et al., GSM AND PERSONAL COMMUNICATIONS HANDBOOK (1998); and JOACHIM TISAL, GSM CELLULAR RADIO TELEPHONY (1997); the GSM Standard 2.17, formally known Subscriber Identity Modules, Functional Characteristics (GSM 02.17 V3.2.0 (January 1995))”; the GSM Standard 11.11, formally known as Specification of the Subscriber Identity Module—Mobile Equipment (Subscriber Identity Module—ME) interface (GSM 11.11 V5.3.0 (July 1996))”; MICHEAL ROBIN & MICHEL POULIN, DIGITAL TELEVISION FUNDAMENTALS (2000); JERRY WHITAKER AND BLAIR BENSON, VIDEO AND TELEVISION ENGINEERING (2003); JERRY WHITAKER, DTV HANDBOOK (2001); JERRY WHITAKER, DTV: THE REVOLUTION IN ELECTRONIC IMAGING (1998); and EDWARD M. SCHWALB, ITV HANDBOOK: TECHNOLOGIES AND STANDARDS (2004).

The user agent application 28, the provider-side pairing application 34, and/or the server-side pairing application 54 may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the exemplary embodiments, allow the present invention to be easily disseminated. A computer program product comprises the user agent application 28, the provider-side pairing application 34, and/or the server-side pairing application 54 stored on the computer-readable medium. Each application comprises computer-readable instructions/code for pairing agents and service providers, as hereinabove explained. The user agent application 28, the provider-side pairing application 34, and/or the server-side pairing application 54 may also be physically embodied on or in any addressable (e.g., HTTP, I.E.E.E. 802.11, Wireless Application Protocol (WAP), or BLUETOOTH®) wireless device capable of presenting an IP address.

While the present invention has been described with respect to various aspects, features, principles, and exemplary embodiments, those skilled and unskilled in the art will recognize the present invention is not so limited. Other aspects, variations, modifications, and alternative embodiments may be made without departing from the spirit and scope of the present invention and are considered within the scope of the concepts disclosed herein and the invention as described by the claims.

What is claimed is:

1. A non-transitory computer-readable storage medium storing instructions for instructing a processor of a device to:
operate a touch screen display of the device in a split mode, wherein the touch screen display is divided into a first half and a second half;
provide control of the first half of the touch screen to a first service provider;
provide control of the second half of the touch screen to a second service provider;
allow a first input to the first half of the touch screen;
provide the first input to the first service provider;
allow a second input to the second half of the touch screen; and
provide the second input to the second service provider.

2. The non-transitory computer-readable storage medium of claim 1, wherein the instructions further instruct a processor of a device to send configuration information describing the device to one of the first and second service providers.

3. The non-transitory computer-readable storage medium of claim 2, wherein the instructions further instruct a processor of a device to:
send a number of available positions of a switch of the device to one of the first and second service providers; and
send a switch map of the device to one of the first and second service providers.

4. The non-transitory computer-readable storage medium of claim 1, wherein the instructions further instruct a processor of a device to receive configuration information that binds a hardware function according to a service provided by one of the first and second service providers.

5. The non-transitory computer-readable storage medium of claim 1, wherein the instructions further instruct a processor of a device to receive configuration information from one of the first and second service providers, wherein the configuration information configures a touch screen of the device.

6. The non-transitory computer-readable storage medium of claim 1, wherein the instructions further instruct a processor of a device to receive a switch configuration for the device from one of the first and second service providers.

7. The non-transitory computer-readable storage medium of claim 1, wherein the instructions further instruct a processor of a device to receive at least one of:
receive an action to bind a switch position of the device from one of the first and second service providers; and
receive a text to bind to a display device from one of the first and second service providers.

8. A device comprising:
a touchscreen;
memory;
an agent application stored in the memory; and
a processor in communication with the memory and the touch screen, the processor configured to:
operate a touch screen display of the device in a split mode, wherein the touch screen display is divided into a first half and a second half;
provide control of the first half of the touch screen to a first service provider;
provide control of the second half of the touch screen to a second service provider;
allow a first input to the first half of the touch screen;
provide the input to the first service provider;
allow a second input to the second half of the touch screen; and
provide the second input to the second service provider.

9. The device of claim 8, wherein the processor is further configured to send configuration information describing the device to one of the first and second service providers.

10. The device of claim 9, wherein the processor is further configured to:
send a number of available positions of a switch of the device to one of the first and second service providers; and
send a switch map of the device to one of the first and second service providers.

11. The device of claim 8, wherein the processor is further configured to receive configuration information that binds a hardware function according to a service provided by one of the first and second service providers.

12. The device of claim 8, wherein the processor is further configured to receive configuration information from one of the first and second service providers, wherein the configuration information configures a touch screen of the device.

13. The device of claim 8, wherein the processor is further configured to receive a switch configuration for the device from one of the first and second service providers.

14. The device of claim 8, wherein the processor is further configured to receive at least one of:
receive an action to bind a switch position of the device from one of the first and second service providers; and
receive a text to bind to a display device from one of the first and second service providers.

15. The device of claim 8, wherein the device is a set-top box.

16. The device of claim 8, wherein the device is a digital video recorder.

17. The device of claim 8, wherein the device is a phone.

18. The device of claim 8, wherein the device is a watch.

19. The device of claim 8, wherein the device is a vehicle electronic.

20. A method comprising:
operating a touch screen display of a device in a split mode, wherein the touch screen display is divided into a first half and a second half;
providing control of the first half of the touch screen to a first service provider;
providing control of the second half of the touch screen to a second service provider;
allowing a first input to the first half of the touch screen;
providing the input to the first service provider;
allowing a second input to the second half of the touch screen; and
providing the second input to the second service provider.
